(19) United States
(12) Patent Application Publication
(10) Pub. No.: US 2002/0092881 A1
(43) Pub. Date: Jul. 18, 2002

(54) Telescopic universal bed rack

(76) Inventor: Cody L. Lambert, Roseburg, OR (US)

Correspondence Address: Cody Lambert, 1451 N.E. Lincoln St., Roseburg, OR, 97470, US

(21) Appl. No.: 09/922,529

(22) Filed: Dec. 11, 2001

Related U.S. Application Data
(60) Provisional application No. 60/225,299, filed on Aug. 15, 2000.

(51) Int. Cl. B60R 9/00; B60R 7/00

(52) U.S. Cl. 224/403; 224/924

(57) ABSTRACT

The Universal telescope bike rack ie. UNIRAK is of a form to which any person using the invention in the prescribed manner for which it was designed, will not have to remove the front wheel on the bicycle in order to transport in the bed of a pickup truck.

Also there is no need for drilling holes in the bed of the pickup truck.

### BRIEF DESCRIPTION OF VIEWS

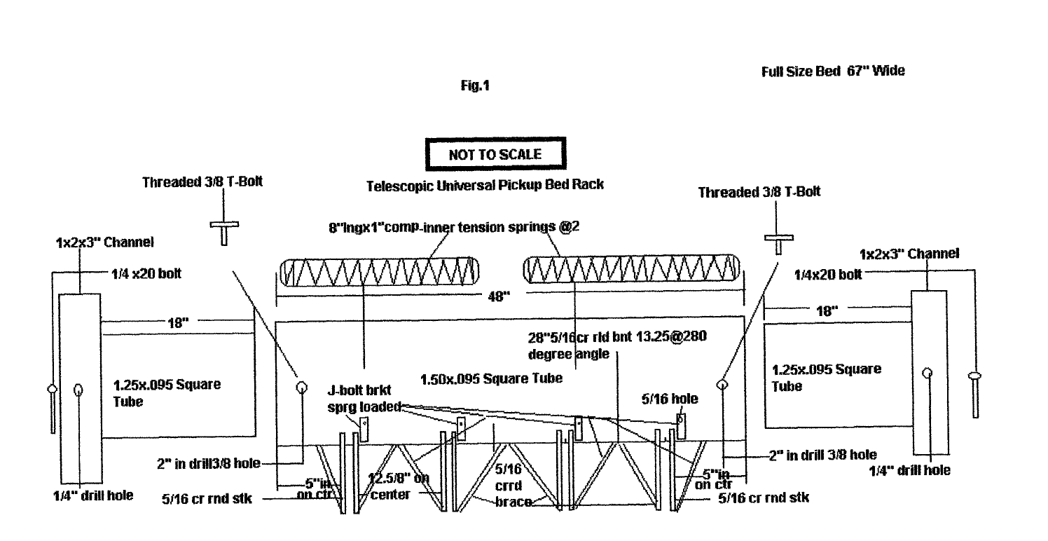

FIG. 1 Not to scale drawing of complete rack system

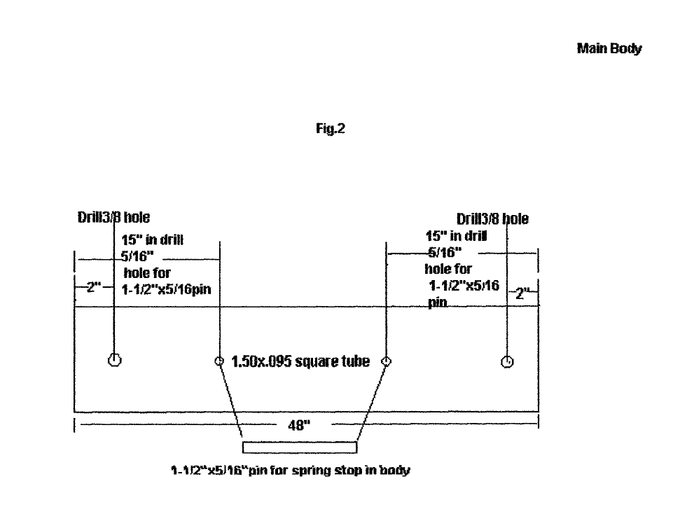

FIG. 2 Main Body

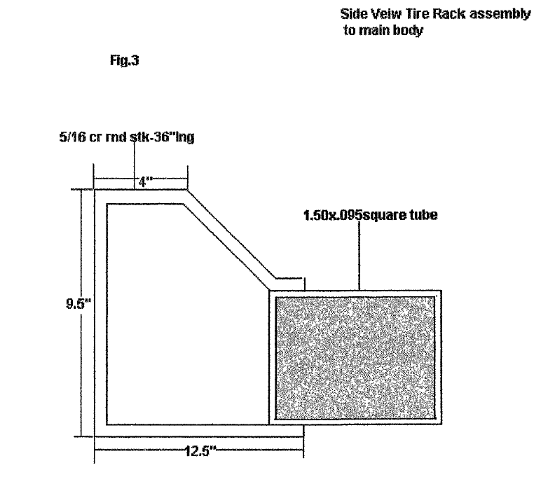

FIG. 3 Side view tire rack assembly

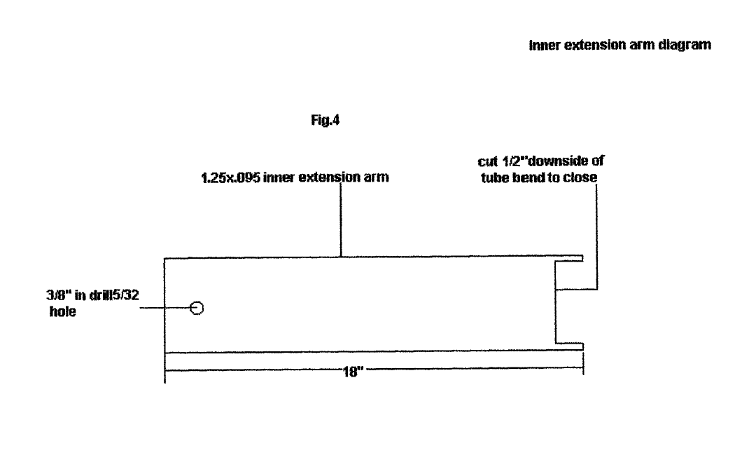

FIG. 4 Inner extension arm diagram

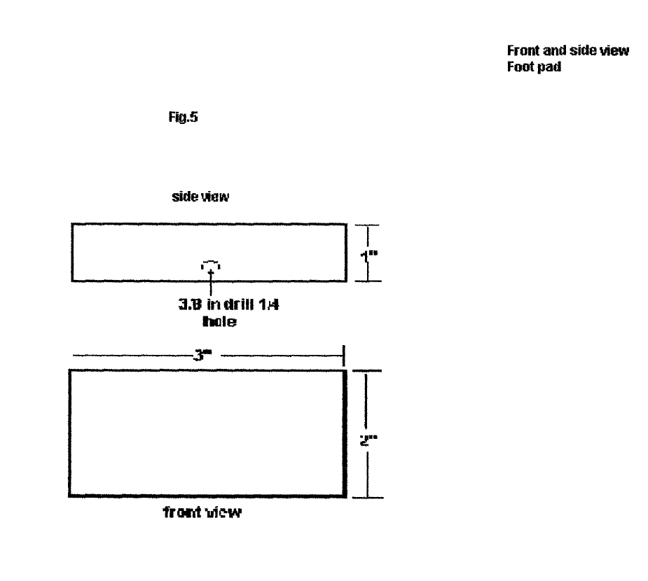

FIG. 5 Front and side view of footpad

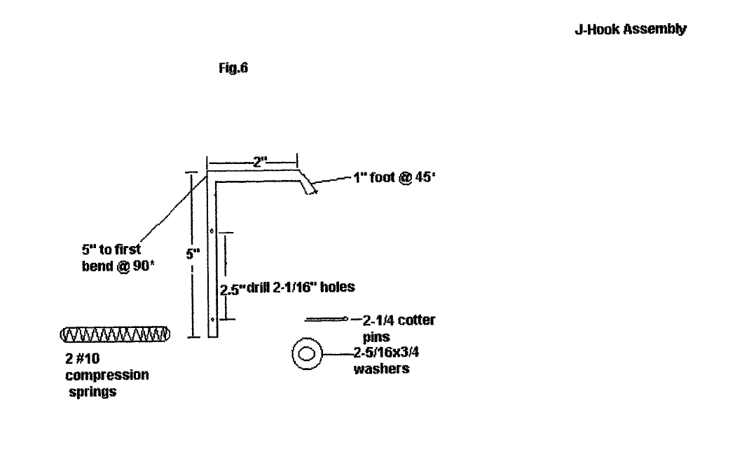

FIG. 6 J-Hook Assembly

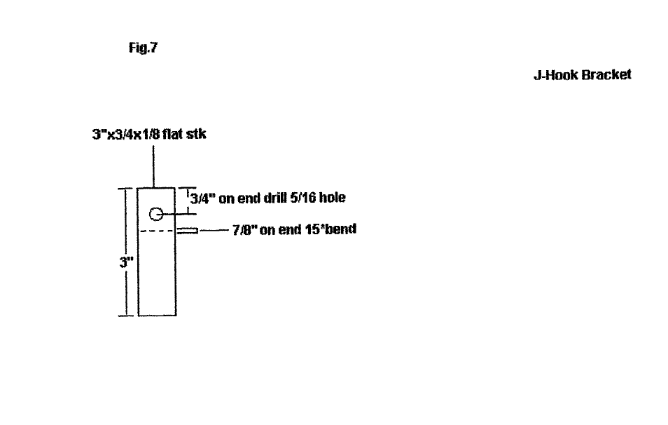

FIG. 7 J-Hook Bracket

### DESCRIPTION IN SUCH OF THE CONSTRUCTION OF THE UNIVERSAL PICK-UP BIKE RACK

Materials involved in the construction: 1.50″×1.50″0.095″ square tubing, 1.25″×1.25″0.095″ square tubing, 5/16″ cold rolled steel, 0.25″×0.75″ flat stock, 2″×0.75″ channel steel No. 10 stainless steel compression springs @ 2 each, No. 24 stainless steel compression springs @ 3-4 each, depending on which rack is being built.

For full size trucks, a 48″ piece of 1.50″×1.50″0.095″ square tube is measured at 2″ in on both ends, and center punched at center for a 5/16″ inch hole, where a ⅜″ course thread nut is welded over the hole; centered. Two pieces of 1.25″×1.25″×0.095″ square tubing cut at 18″ are then stood on end, and on one end a cut is made on opposing sides down 0.75″ then the two sides are bent over forming a seal on one end. This is to provide a stop for the compression spring inside of the main body. On the other end, at 0.50″ in, a 0.25″ hole is centered and drilled through both sides. A 3″ piece of 2″×0.75″ channel steel is measured at 0.25″ from channel side centered where a 0.25″ hole is drilled through both sides. This foot is then held on the square end of the 1.25″×1.25″×0.095″ square tube with a 0.25″×20 carriage bolt with self-locking nut. At 15″ in on both ends of the main body, a 5/16″ hole is drilled through both sides of the tube, to allow for a 2″ piece 5/16″ round stock to be inserted through the hole, then welded over on both sides. This is the other internal compression spring stop. Then 8 pieces of 5/16″ cold rolled steel cut at 38″, are bent at 90 degrees at 14″, then again a 90 degree bend at 9″, then a 30 degree bend at 3″, then another 30 degree opposing bend at 10″. These are placed in pairs at 1.75″ apart over and under the main body. One on each end inset at 5″ center. Then the other two centered at 12.5/8″ accordingly. These are then welded to the main body on top and underneath. Then 5/16″ cold rolled steel is used for the bracing, between the uprights, thus a 23.50″ piece @ 2 each with 65 degree bends with a 5 degree bend on each end are clamped between the uprights, thus tacked down, then the main bend is welded to the main body. On each end a 11.50″ piece of 5/16″ cold rolled steel with a 5 degree bend on each end is thus welded to the upright and main body, thus supplying very rigid support. Then a 3″ piece of 0.25″×0.75″ flat stock is drilled on one end at 0.7541 with a 5/16″ hole, then a 15 degree bend on same end. This is then welded to the main body on the right side of the right upright with bend facing and hole facing up. This is to allow for the spring loaded J-Hook assembly to be inserted through the 5/16″ hole. The J-Hook is comprised of a 8.50″ piece of 5/16″ cold rolled steel bent at a 90 degree angle at 5″ then another 5 degree bend at 2.50″. A 1/16″ hole at 0.50″ and 3″ respectively is drilled through the long side of the J-Hook assembly to allow for the cotter keys to be inserted through the assembly for spring retention.

What I claim as my invention is:

1. I, Cody Lambert have invented an apparatus that is used in the bed of a pickup truck to support one or more bicycles. When the apparatus is not being used in the bed of the truck, it can also be used for storage in ones garage or at a campsite while camping.
Also, the apparatus does not require the removal of the front wheel from the bicycles. The retention device that keeps the bicycles from rolling out of the rack is unique in itself.
